(19) United States
(12) Patent Application Publication
(10) Pub. No.: US 2026/0120517 A1
(43) Pub. Date: Apr. 30, 2026

(54) PRIVACY ORIENTED INSIGHT GENERATION

(71) Applicant: CORSIGHT.AI, Tel Aviv (IL)

(72) Inventors: Matan NOGA, Tel Aviv (IL); Mark Firger, Tel Aviv (IL)

(73) Assignee: CORSIGHT.AI, Tel Aviv (IL)

(21) Appl. No.: 18/928,140

(22) Filed: Oct. 27, 2024

(51) Int. Cl. G06V 40/50; G06V 20/52; G06V 40/16

(52) U.S. Cl. CPC G06V 40/53; G06V 20/53; G06V 40/172

(57) ABSTRACT

A method of privacy oriented insight generation, the method includes (a) receiving by a volatile cache memory unit, during an occurrence of an event that is defined by one or more programmable rules, face-recognition based indicators that indicate that one or more persons were captured by one or more cameras during the occurrence of the event, the one or more cameras are associated with the event and, wherein each person of the one or more persons has a unique face-recognition based indicator that lacks personally identifiable information regarding the person; (b) processing the face-recognition based indicators based on the one or more programmable rules to provide an insight related decision; wherein the processing ends during the event or immediately after a completion of the event; and (c) deleting the face-recognition based indicators from the volatile cache memory unit upon a completion of the processing.

### BACKGROUND

The European Union has introduced the General Data Protection Regulation (GDPR) that requires organizations to safeguard personal data and uphold the privacy rights of anyone in European Union territory. The regulation includes seven principles of data protection that must be implemented and eight privacy rights that must be facilitated. It also empowers member state-level data protection authorities to enforce the GDPR with sanctions and fines.

Other countries are also to expected to increase the protection of personal data.

These personal data protection measures must be taken into account when processing images acquired from surveillance cameras.

There is also a need to increase the capabilities of face detection systems—beyond the mere identification of a recognized person that has his face captured by a camera.

### SUMMARY

There is provided a method, a non-transitory computer readable medium and a system as illustrated in the application.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a computerized system;

FIG. 2 illustrates an example of a method; and

FIG. 3 illustrates an example of a method.

### DETAILED DESCRIPTION

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

According to an embodiment there is provided a method of privacy oriented insight generation that includes (a) receiving by a volatile cache memory unit, during an occurrence of an event that is defined by one or more programmable rules, face-recognition based indicators that indicate that one or more persons were captured by one or more cameras during the occurrence of the event, the one or more cameras are associated with the event and, wherein each person of the one or more persons has a unique face-recognition based indicator that lacks personally identifiable information regarding the person, (b) processing the face-recognition based indicators based on the one or more programmable rules to provide an insight related decision; wherein the processing ends during the event or immediately after a completion of the event; and (c) deleting the face-recognition based indicators from the volatile cache memory unit upon a completion of the processing.

According to an embodiment, the one or more programmable rules define the one or more cameras are associated with the event.

According to an embodiment, the one or more programmable rules can be changed or be replaced by other one or more programmable rules. The change or replacement can be done by a programming act made by an authorized entity. According to an embodiment different sets of one or more rules each may be programmed in advance and can be dynamically associated with one or more volatile cache memories. For example different events can be associated with different sets and may be allocated with different volatile cache memories or allocated at different times with he same volatile cache memory.

According to an embodiment, the face-recognition based indicator of a person is unique in the sense that a value of a face-recognition based indicator of one person differs from a face-recognition based indicator of another person.

According to an embodiment, the face-recognition based indicator of a person lacks personally identifiable information regarding the person indicates that the face-recognition based indicator per se does not disclose the identity of the person. A party (being an authorized party or even an unauthorized party) that access the cache will not be able to identify, based on the content of the cache, which persons are associated with the content of the cache.

According to an embodiment, a single instance of a face-recognition based indicator that is cached in the volatile cache memory unit is generated by face recognition process. According to an embodiment, the face recognition process includes capturing an image of at least a face of a person by a camera (or obtaining an image that was captured by the camera), generating a face signature, comparing the face signature to reference face signatures (may or may be associated with identified persons) to provide a face recognition result.

According to an embodiment, the face-recognition based indicator is compact—for example may range between four and ten bits or between six and fifteen bits. According to an embodiment, the length of the face-recognition based indicator is determined based on the number (#N) of different persons that are expected to appear during an event—and may be for example the minimal or close to minimal (for example have an additional one to three bits) than the number of different persons that are expected to appear during an event. For example—the length may be equal to TRUNC[log2(#N)]+1.

According to an embodiment the face recognition process is executed by a computerized system that is safe guarded and a third party that gains access to the volatile cache memory unit has to undergo additional identification and/or access control procedures in order to obtain information that identifies the person captured by the camera. Examples of face recognition processes are illustrated in U.S. patent application Ser. No. 17/455,398 which is incorporated herein by reference and/or in U.S. patent Ser. No. 17/304,814 which is incorporated herein by reference.

According to an embodiment, the content of the volatile cache memory is not access protected.

According to an embodiment a face recognition process, one succeeds provide metadata regarding the face recognized person—whereas the metadata may include the name of the person and/or any personal identifier of the person and/or any other personal information regarding the face identifier person.

According to an embodiment, the metadata—especially name of the person and/or any personal identifier of the person and/or any other personal information regarding the face identifier person is not sent to the volatile cache memory—and is safeguarded from parties that gain access to the volatile cache memory.

According to an embodiment the face-recognition based indicator has a value that is generated based on the outcome of the face recognition process-and it may be generated in any manner—using for example an injective function-based on the signature of the image captured by the data, based on a reference signature that is stored in a reference database, and the like. Nevertheless—the face-recognition based indicator is not a signature that may be used per se to identify the person or to retrieve personal information about the person.

Examples of a face-recognition based indicator includes an outcome of applying an injective function on a face signature, whereas the injunctive function is defined so that the face signature can not be reconstructed based on the face-recognition based indicator, an address of an entry in a reference database that stores reference face signatures whereas the reference database is not accessible to a party that gains access to the volatile cache memory, an outcome of applying an injective function on an address of an entry in a reference database, whereas the injunctive function is defined so that the an address of an entry in a reference database cannot be reconstructed based on the face-recognition based indicator, applying a combination of a random function and an injunctive function on any person related outcome of the face recognition process—so that following the appliance of a random function the uniqueness of the random value is checked—and if not unique to the person—another iteration of generation the random value is repeated—till finding a unique value related to the person.

According to an embodiment, the one or more programmable rules define one or more timing relationships between capture of the one or more persons by the one or more cameras. A timing relationship may include the time difference between an appearance of a person before one camera to the appearance of the person in front another camera, time of stay of the person in front of the same camera, time difference between appearances of different persons in front of the same camera, time difference between an appearance of a person in front of one camera to an appearance of another person in front of another camera, and the like. The timing relationships may be associated with minimal values, maximal values, a range of values, and the like.

According to an embodiment, using a volatile cache memory that is tailored to a defined event and the simplicity and/or the compactness of mainly storing the face-recognition based indicators dramatically reduces the processing and/or storage resources associated with reaching an insight related decision—and also increases the accuracy of the insight related decision—as it is based on simple and well defined face-recognition based indicators and small amount of overall data.

The deletion of the face-recognition based indicators following the processing dramatically reduces the burden associated with volatile cache memory management which protecting privacy.

Using events that can be easily defined using one or more programmable rules allows monitoring multiple events simultaneously while allocating an insignificant amount of resources.

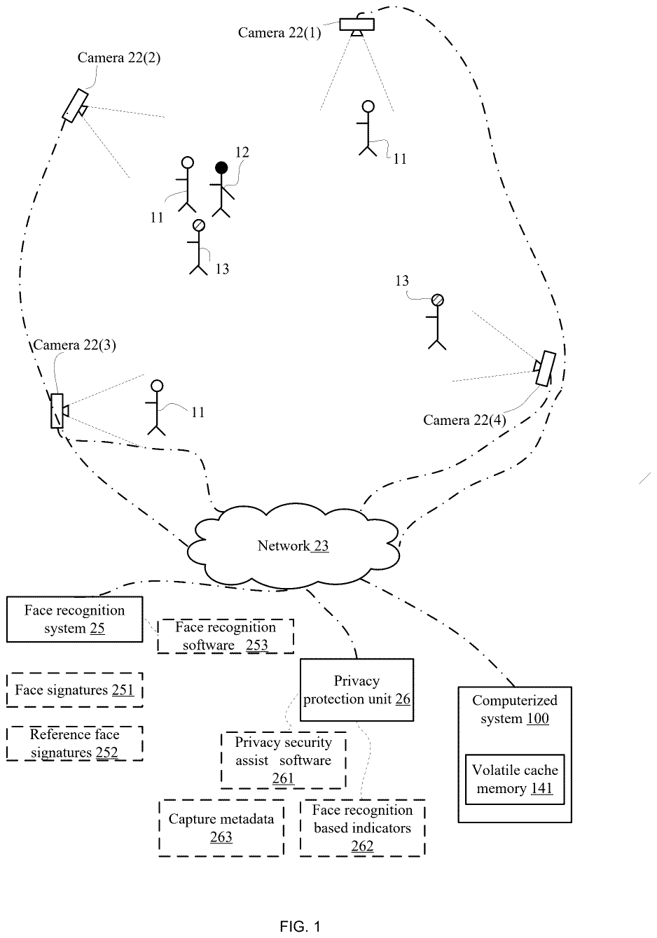

FIG. 1 illustrates an example of multiple cameras such as first, second, third and fourth cameras 22(1)-22(4) each having its own camera field of view, the multiple cameras capture one or more persons at one or more points in time—for example first person 11 is captured by first camera 22(1), second camera 22(2) and third camera 22(3) at three different points in time. Yet for another example—second person 12 is captured by second camera 22(2). Third person 13 is captured by second and fourth cameras 22(2) and 22(4) at two different points in time.

There may be any number of camera that are located in any manner. The field of views of two or more camera may not overlap or may at least partially overlap.

Images from the four cameras are conveyed over network 23 to the face recognition system 25 that attempts to recognize the face of these persons and provides an outcome of the face recognition process. According to an embodiment, the face recognition system 25 is configured to perform the face recognition process by executing face recognition software 253 to provide face signatures 251 and to perform a matching process with reference face signatures 252.

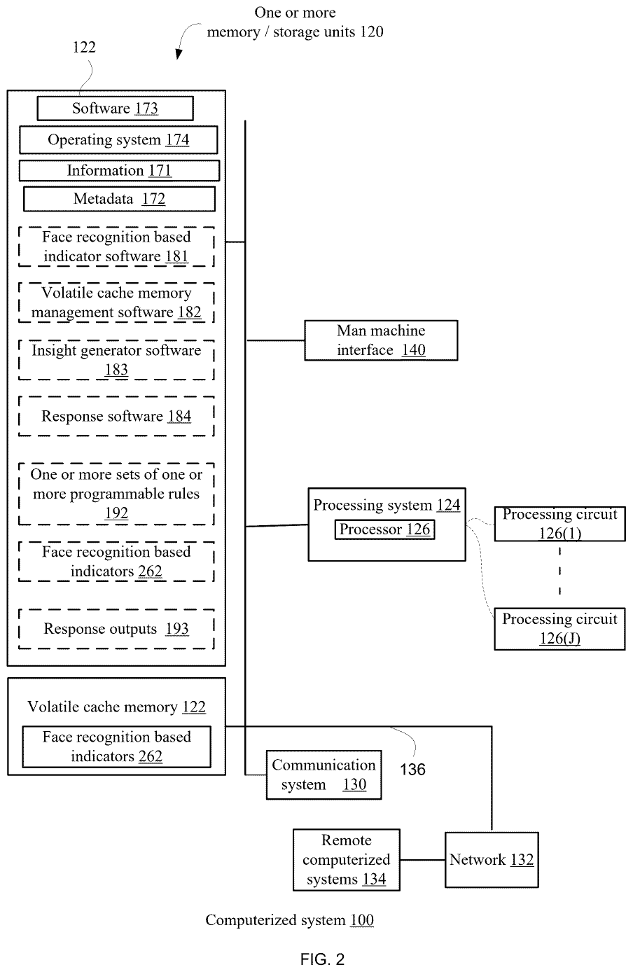

Privacy protection unit 26 is configured to convert the outcome of the face recognition process to the face-recognition based indicator that is provided to computerized system 100 of FIG. 2. According to an embodiment, the privacy protection unit 26 is configured to execute a privacy security assist software 261 for generating the face-recognition based indicators 262—for example by using an injective function. The face-recognition based indicators 262 are associated with capture metadata 263 such as capturing camera metadata and time of capture metadata.

According to an embodiment, the privacy protection unit 26 is included in computerized system 100.

According to an embodiment, the face recognition system 25 (or any part thereof) is included in computerized system 100.

FIG. 2 illustrates an example of a computerized system 100.

The computerized system 100 includes a man-machine interface (MMI) 140, which can either be built-in or connected to an MMI controller (not shown). The system also consists of a communication system 130, one or more memory and/or storage units 120 which includes volatile cache memory 121 and other memory/storage elements 122, wherein the access to each one of the volatile cache memory 121 and other memory/storage elements 122 is controlled, and a processing system 124 with a processor 126. The other memory/storage elements may include multiple memory banks, providing flexibility and scalability in the system's storage capabilities.

The system itself can be any type of computing device, such as a desktop, laptop, server, or similar, and may also include or interface with a sensing unit or a controller.

According to an embodiment, the system or at least a part of the system (for example the volatile cache memory) is included in a camera that capture images related to the event, or included in one or more cameras that capture images related to the event. The cameras may perform distributed processing to implement the functionality of processor 126.

In one implementation, the computerized system 100 is capable of communicating with a network 132, allowing it to interact with other remote computerized systems 134 connected to the same network.

The communication system 130 plays a key role in enabling information exchange between the memory and/or storage units 120 and other system components, including the network 132. This network link allows for communication with remote computerized systems and facilitates interactions with the man-machine interface 140.

The memory and/or storage units 120 store software, a term that includes code, firmware, instructions, commands, and related elements. Any reference to “software” should be interpreted broadly to cover these components.

The processor 126 is composed of multiple processing units, labeled 126(1) to 126(J), where J represents an integer greater than one. When referring to a singular unit or item, the same reference applies to multiple units or items. For instance, “processor” can refer to multiple processors, and similarly, “communication system 130” can represent multiple communication systems.

The other memory/storage elements 122 of memory and/or storage units 120 can include both volatile memory, such as random-access memory (RAM), and non-volatile memory, such as read-only memory (ROM). These different memory types offer a balance of speed and persistence, suited to various tasks in the system. The non-volatile memory units serve as mass storage devices, ensuring the long-term storage of computer code, executable instructions, data structures, program modules, and other essential data for the processor or other components.

The system is designed to handle any kind of data within its memory and/or storage units. This flexibility ensures effective management of various types of content, whether software, data, or other information.

The memory and/or storage units 120 not only store software but are also configured to contain firmware, one or more operating systems, and any necessary data or metadata essential to executing the methods described in this application.

As noted earlier, the memory and/or storage units 120 store software, and the term “software” applies equally to any form of code, firmware, instructions, commands, or similar elements. This ensures all the necessary functions can be carried out by the system.

Communication between various system components occurs through different communication elements or protocols. While the communication system 130 is an example, other communication elements can also be used to support seamless information exchange.

The communication system 130 may be connected to a bus 136, which could represent a variety of bus structures, such as a memory bus, peripheral bus, accelerated graphics port, or processor bus.

Network 132, external to the computerized system, facilitates communication between the system and at least one remote computing system or vehicle. These remote systems could be personal computers, routers, laptops, peer devices, network computers, or other common network nodes. Logical connections between the processor and remote systems may occur via a local area network or wide area network. These connections can be established through network adapters, part of the communication system 130, and can function in both wired and wireless environments. These networking setups are common in larger systems like enterprise networks, office settings, intranets, or the internet.

The memory and/or storage units 120 are also designed to store essential system components such as the operating system 174, information 171, metadata 172, and various software applications 173 critical to the system's operations.

Different system components communicate through various communication elements or protocols. While the communication system 130 is one example, the system can support other communication elements as required to ensure efficient data transfer across all components. According to an embodiment, the memory and/or storage units 120 stores at least one of: operating system 174, information 171, metadata 172, and software 173.

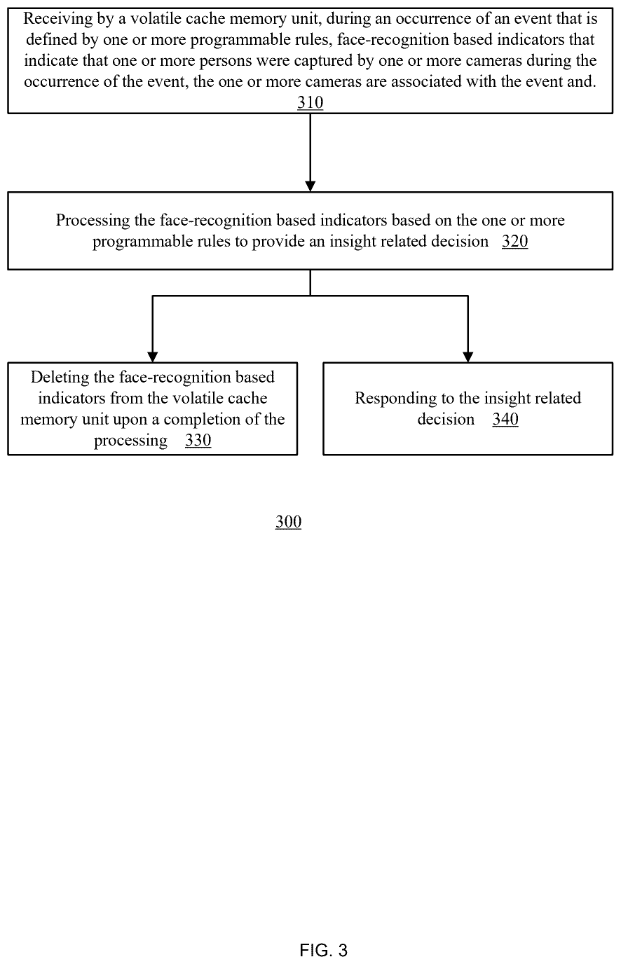

Examples of software include at least one of (a) face recognition based indicator software 181 configured to manage face recognition based indicators—for example—reading the face recognition based indicators and/or triggering the storage of the face recognition based indicators in the volatile cache memory (see, for example step 510 of FIG. 3), (b) volatile cache memory management software 182 for managing the access requests related to the volatile cache memory—for example for deletion and/or insertion of the face recognition based indicator in the volatile cache memory (see, for example steps 510 and 530 of FIG. 3), (c) insight generator software 182 for processing the face recognition based indicators stored in the volatile cache memory based on one or more programmable rules to provide an insight related decision (see step 520 of FIG. 3), and/or (d) response software 184 for responding to the insight related decision (see, for example step 540 of FIG. 3).

Only one or some of these software may be stored in the one or more memory/storage units 120.

Examples of information and/or metadata include at least one of (a) one or more sets of one or more programmable rules 192, (b) face recognition based indicators 262 and/or response outputs. Only one or some of these information and/or metadata may be stored in the one or more memory/storage units 120.

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

Various units and/or components are in communication with each other using any communication elements and/or protocols. An example of a communication system is denoted 130. Other communication elements may be provided.

According to an embodiment, processing system 124 is configured to perform method 600 while executing software.

According to an embodiment, processing system 124 is configured to perform at least one of the following when executing software:
Receive by a volatile cache memory unit, during an occurrence of an event that is defined by one or more programmable rules, face-recognition based indicators that indicate that one or more persons were captured by one or more cameras during the occurrence of the event, the one or more cameras are associated with the event and. Each person of the one or more persons has a unique face-recognition based indicator that lacks personally identifiable information regarding the person.
Process the face-recognition based indicators based on the one or more programmable rules to provide an insight related decision. The processing ends during the event or immediately after a completion of the event.
Delete the face-recognition based indicators from the volatile cache memory unit upon a completion of the processing.
Respond to the insight related decision.

FIG. 3 illustrates an example of method 300 for privacy oriented insight generation.

According to an embodiment, method 300 starts by step 310 of receiving by a volatile cache memory unit, during an occurrence of an event that is defined by one or more programmable rules, face-recognition based indicators that indicate that one or more persons were captured by one or more cameras during the occurrence of the event, the one or more cameras are associated with the event and. Each person of the one or more persons has a unique face-recognition based indicator that lacks personally identifiable information regarding the person.

According to an embodiment, the face-recognition based indicator of a person is unique in the sense that a value of a face-recognition based indicator of one person differs from a face-recognition based indicator of another person.

According to an embodiment, the face-recognition based indicator of a person lacks personally identifiable information regarding the person indicates that the face-recognition based indicator per se does not disclose the identity of the person. A party (being an authorized party or even an unauthorized party) that access the cache will not be able to identify, based on the content of the cache, which persons are associated with the content of the cache.

According to an embodiment, a single instance of a face-recognition based indicator that is cached in the volatile cache memory unit is generated by face recognition process. According to an embodiment, the face recognition process includes capturing an image of at least a face of a person by a camera (or obtaining an image that was captured by the camera), generating a face signature, comparing the face signature to reference face signatures (may or may be associated with identified persons) to provide a face recognition result.

According to an embodiment the face recognition process is executed by a computerized system that is safe guarded and a third party that gains access to the volatile cache memory unit has to undergo additional identification and/or access control procedures in order to obtain information that identifies the person captured by the camera. Examples of face recognition processes are illustrated in U.S. patent application Ser. No. 17/455,398 which is incorporated herein by reference and/or in U.S. patent Ser. No. 17/304,814 which is incorporated herein by reference.

According to an embodiment a face recognition process, one succeeds provide metadata regarding the face recognized person—whereas the metadata may include the name of the person and/or any personal identifier of the person and/or any other personal information regarding the face identifier person.

According to an embodiment, the metadata—especially name of the person and/or any personal identifier of the person and/or any other personal information regarding the face identifier person is not sent to the volatile cache memory—and is safeguarded from parties that gain access to the volatile cache memory.

According to an embodiment the face-recognition based indicator has a value that is generated based on the outcome of the face recognition process—and it may be generated in any manner—using for example an injective function—based on the signature of the image captured by the data, based on a reference signature that is stored in a reference database, and the like. Nevertheless—the face-recognition based indicator is not a signature that may be used per se to identify the person or to retrieve personal information about the person.

Examples of a face-recognition based indicator includes an outcome of applying an injective function on a face signature, whereas the injunctive function is defined so that the face signature can not be reconstructed based on the face-recognition based indicator, an address of an entry in a reference database that stores reference face signatures whereas the reference database is not accessible to a party that gains access to the volatile cache memory, an outcome of applying an injective function on an address of an entry in a reference database, whereas the injunctive function is defined so that the an address of an entry in a reference database cannot be reconstructed based on the face-recognition based indicator, applying a combination of a random function and an injunctive function on any person related outcome of the face recognition process—so that following the appliance of a random function the uniqueness of the random value is checked—and if not unique to the person—another iteration of generation the random value is repeated—till finding a unique value related to the person.

According to an embodiment, step 310 is preceded by generating the face-recognition based indicator.

According to an embodiment, step 310 is followed by step 320 of processing the face-recognition based indicators based on the one or more programmable rules to provide an insight related decision. The processing ends during the event or immediately after a completion of the event.

According to an embodiment, “immediately”—is within a range of 0.1-10 seconds, within a range of 1-200 seconds, within a range of 1-20 minutes, within less than 1-20 hours, more than 20 hours, and the like.

According to an embodiment, the length of the “immediately after” period should be as short possible.

According to an embodiment, the length of the “immediately after” is related to the volatile cache memory capacity, the amount and/or size of face-recognition based indicators that should be stored to successfully execute the method and/or the rate of reception of the face-recognition based indicators to the volatile cache memory.

According to an embodiment, an insight related decision provides an indication of what happened during the event—for example whether the one or more programmable rules were violated or were successfully followed.

According to an embodiment an event represents a pattern of appearances defined by the one or more programmable rules.

According to an embodiment, step 320 is followed by step 330 of deleting the face-recognition based indicators from the volatile cache memory unit upon a completion of the processing. The deletion should occur as soon as possible following the completion of the processing.

According to an embodiment, step 330 is followed by step 340 of responding to the insight related decision—for example sending an alert or an indication regarding the insight related decision, triggering additional image acquisitions—for example under different acquisition condition, and the like.

According to an embodiment, the one or more programmable rules define one or more timing relationships between capture of the one or more persons by the one or more cameras.

A timing relationship may include the time difference between an appearance of a person before one camera to the appearance of the person in front another camera, time of stay of the person in front of the same camera, time difference between appearances of different persons in front of the same camera, time difference between an appearance of a person in front of one camera to an appearance of another person in front of another camera, and the like. The timing relationships may be associated with minimal values, maximal values, a range of values, and the like.

### Maximal Allowable Time Difference Scenario

According to an embodiment, the method is applied to determine whether a person stayed within a region up to a maximal allowable time difference. For example—having a passenger that departed from an airplane reach a checkpoint within the airport within X minutes.

According to an embodiment, the one or more programmable rules define a maximal allowable time (for example X minutes) difference between a capture of a person by a first camera to a capture of the person by a second camera.

According to an embodiment, the processing of step (see, for example step 510 of FIG. 3) includes searching for a missing person, wherein the missing person is a person that was captured by the first camera and was not captured by the second camera within the maximal allowable time difference after the capture of the person by the first camera.

### Sequence of Appearances

According to an embodiment, the one or more programmable rules define a certain sequence of appearances of a person within fields of views of a group of cameras. The sequence may be related to a defined order of appearance or may not be related to a defined order of appearance.

According to an embodiment the certain sequence of appearances (or at least one or more appearances of the sequence) is associated with timing constraints between the appearances.

According to an embodiment, the processing of step 520 includes searching for persons that follow the certain sequence of appearances.

According to an embodiment, the processing of step 520 includes searching for persons that fail to follow the certain sequence of appearances.

Examples of sequence of appearances include monitoring a path of patrolling guard, estimating a promoted item within a field of view of one camera was sold—based on a timing relationship between accessing he item and reaching a point of sale, and the like.

An example of sequence monitoring is provided in relation to the example set forth in FIG. 1.

Assuming that according to one or more programmable rules related to a first event—the first person 11 has to progress from being within the field of view of first camera 21 to being within the field of view of second camera within up to a first maximal period and then continue to being within he field of view of the third camera without any timing constraint. Under these assumptions:
First person is captured by first camera 21 at a point of time T1.
A first person face-recognition based indicator (IN-1) is generated, is associated with capture metadata such as first camera metadata and capture time metadata, and is stored in the volatile cache memory at an insignificant delay following T1.
The first person is captured by second camera 22 at a point of time T2.
A first face-recognition based indicator (IN-1) is generated, is associated with capture metadata such as second camera metadata and capture time metadata, and is stored in the volatile cache memory at an insignificant delay following T2.
First person is captured by third camera 23 at a point of time T3.
A first face-recognition based indicator (IN-1) is generated, is associated with capture metadata such as third camera metadata and capture time metadata, and is stored in the volatile cache memory at an insignificant delay following T3.
A processing is executed to determine whether the event was successfully completed. In this case the first person fulfilled followed the required sequence and the processing also checks whether the time difference between T2 and T1 does not exceed the first maximal period.
Following the processing, the three instances of the first face recognition based indicator IN-1 are deleted from the volatile cache memory.

Assuming that according to one or more programmable rules related to a second event the second person 12 has to progress from being within the field of view of second camera 22 to being within the field of view of any other camera of the first, third and fourth camera within a second maximal period.
Second person is captured by second camera 22 at a point of time T4.
A second person face-recognition based indicator (IN-2) is generated, is associated with capture metadata such as second camera metadata and capture time metadata, and is stored in the volatile cache memory at an insignificant delay following T4.
The processing of the volatile cache memory identifies that the second person does not appear in front of any of the other cameras—and is regarded to be a missing person.
Following the processing, the single instance of the second face recognition based indicator IN-2 is deleted from the volatile cache memory.

### Crowd Monitoring

According to an embodiment the event is related to a crowd and the one or more programmable rules define one or more required insights related to persons in the crowd—such as a minimal time of appearance of a person in order to have the person regarded to be a part of the crowd.

According to an embodiment, the crowd monitoring empowers users to manage and receive alerts related to queues and crowded areas that retain more individuals than a specified number for a duration exceeding the predefined time frame. According to an embodiment, the method is configured to keep counting the duration of this person's appearance even if the person was hidden from the camera for a defined period (also defined by the one or more programmable rules)—for example for a few seconds.

According to an embodiment, the one or more programmable rules define a minimal duration of appearance of a person within a crowd in front of a camera to define the person as belonging to the crowd.

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of the claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

We claim

1. A method of privacy oriented insight generation, comprising:
receiving by a volatile cache memory unit, during an occurrence of an event that is defined by one or more programmable rules, face-recognition based indicators that indicate that one or more persons were captured by one or more cameras during the occurrence of the event, the one or more cameras are associated with the event and, wherein each person of the one or more persons has a unique face-recognition based indicator that lacks personally identifiable information regarding the person;
processing the face-recognition based indicators based on the one or more programmable rules to provide an insight related decision; wherein the processing ends during the event or immediately after a completion of the event; and
deleting the face-recognition based indicators from the volatile cache memory unit upon a completion of the processing.

2. The method according to claim 1, wherein the one or more programmable rules define one or more timing relationships between capture of the one or more persons by the one or more cameras.

3. The method according to claim 1, wherein the one or more programmable rules define a maximal allowable time difference between a capture of a person by a first camera to a capture of the person by a second camera.

4. The method according to claim 3, wherein the processing comprises searching for a missing person, wherein the missing person is a person that was captured by the first camera and was not captured by the second camera within the maximal allowable time difference after the capture of the person by the first camera.

5. The method according to claim 1, wherein the one or more programmable rules define a certain sequence of appearances of a person within fields of views of a group of cameras.

6. The method according to claim 5, wherein the processing comprises searching for persons that follow the certain sequence of appearances.

7. The method according to claim 5, wherein the processing comprises searching for persons that fail to follow the certain sequence of appearances.

8. The method according to claim 1, wherein the one or more programmable rules define a minimal duration of appearance of a person within a crowd in front of a camera to define the person as belonging to the crowd.

9. The method according to claim 1, comprising responding to insight related decision.

10. A non-transitory computer readable medium of privacy oriented insight generation, that stores instructions executable by a processor for:
receiving by a volatile cache memory unit, during an occurrence of an event that is defined by one or more programmable rules, face-recognition based indicators that indicate that one or more persons were captured by one or more cameras during the occurrence of the event, the one or more cameras are associated with the event and, wherein each person of the one or more persons has a unique face-recognition based indicator that lacks personally identifiable information regarding the person;
processing the face-recognition based indicators based on the one or more programmable rules to provide an insight related decision; wherein the processing ends during the event or immediately after a completion of the event; and
deleting the face-recognition based indicators from the volatile cache memory unit upon a completion of the processing.

11. The non-transitory computer readable medium according to claim 10, wherein the one or more programmable rules define one or more timing relationships between capture of the one or more persons by the one or more cameras.

12. The non-transitory computer readable medium according to claim 10, wherein the one or more programmable rules define a maximal allowable time difference between a capture of a person by a first camera to a capture of the person by a second camera.

13. The non-transitory computer readable medium according to claim 12, wherein the processing comprises searching for a missing person, wherein the missing person is a person that was captured by the first camera and was not captured by the second camera within the maximal allowable time difference after the capture of the person by the first camera.

14. The non-transitory computer readable medium according to claim 10, wherein the one or more programmable rules define a certain sequence of appearances of a person within fields of views of a group of cameras.

15. The non-transitory computer readable medium according to claim 14, wherein the processing comprises searching for persons that follow the certain sequence of appearances.

16. The non-transitory computer readable medium according to claim 14, wherein the processing comprises searching for persons that fail to follow the certain sequence of appearances.

17. The non-transitory computer readable medium according to claim 10, wherein the one or more programmable rules define a minimal duration of appearance of a person within a crowd in front of a camera to define the person as belonging to the crowd.

18. The non-transitory computer readable medium according to claim 10, that stores instructions executable by the processor for responding to insight related decision.
